(19) United States
(12) Patent Application Publication
(10) Pub. No.: US 2026/0343665 A1
(43) Pub. Date: Oct. 29, 2026

(54) METHOD, DEVICE AND COMPUTER STORAGE MEDIUM OF COMMUNICATION

(71) Applicant: NEC Corporation, Tokyo (JP)

(72) Inventors: You LI, Beijing (CN); Gang WANG, Beijing (CN)

(73) Assignee: NEC Corporation, Tokyo (JP)

(21) Appl. No.: 19/106,021

(22) PCT Filed: Aug. 25, 2022
(86) PCT No.: PCT/CN2022/114946

§ 371 Date: Feb. 24, 2025

(51) Int. Cl. H04W 76/27; H04W 88/04; H04W 92/18

(52) U.S. Cl. CPC H04W 76/27; H04W 88/04; H04W 92/18

(57) ABSTRACT

Example embodiments of the present disclosure relate to a method of communication. A first network device receives, at a first network device, a first message explicitly or implicitly indicating a successful transmission of a path switch configuration to a first terminal device, the first terminal device being connected to the first network device via a relaying path comprising a second terminal device and being switched to a target path between the first terminal device and a second network device. The first network device transmitting, to the second terminal device, one of the following: a second message used for re-configuring the relaying path, or a third message used for triggering the second terminal device to apply a previously-received second message used for re-configuring the relaying path.

### TECHNICAL FIELD

Embodiments of the present disclosure generally relate to the field of telecommunication, and in particular, to methods, devices and computer storage media for path switching.

### BACKGROUND

In wireless communication network device, a terminal device may communicate with the network device via a direct path or an indirect path. Specifically, in case of the direct path, the terminal device may communicate with the network device directly, while in case of the indirect path, the terminal device may communicate with the network device via at least one relay terminal device. Further, the location of the terminal device and the communication condition may change over time. In order to maintain a continuous communication with the network, the terminal device may be switched to a new path or connected to a new network device sometimes, i.e., performing a path switch.

Generally speaking, during a path switch, in case that the source path is an indirect path, the release of source path should be performed after a successful transmission of a path switch command to the terminal device. However, in case of the source network device and the target network device are deployed at different physical devices (also referred to as inter-gNB) and the source path is an indirect path, the source network device does not know whether the path switch command has been transmitted successfully, which may cause that the source path may be released before the successful transmission of a path switch command, which is an unexpected result. Thus, in case of inter-gNB, how to control the release of the relaying path during a path switch needs to be further discussed.

### SUMMARY

In general, embodiments of the present disclosure provide methods, devices and computer storage media of path switching.

In a first aspect, there is provided a method performed by a first network device. The method comprises: receiving, at a first network device, a first message explicitly or implicitly indicating a successful transmission of a path switch configuration to a first terminal device, the first terminal device being connected to the first network device via a relaying path comprising a second terminal device and being switched to a target path between the first terminal device and a second network device; and transmitting, to the second terminal device, one of the following: a second message used for re-configuring the relaying path, or a third message used for triggering the second terminal device to apply a previously-received second message used for re-configuring the relaying path.

In a second aspect, there is provided a method performed by a second network device. The method comprises: receiving, at a second network device, a fourth message explicitly or implicitly indicating a successful transmission of a path switch configuration to a first terminal device, the first terminal device being connected to a first network device via a relaying path comprising a second terminal device and being switched to a target path between the first terminal device and the second network device; and transmitting, to the first network device, a first message explicitly or implicitly indicating the successful transmission of the path switch configuration to the first terminal device.

In a third aspect, there is provided a method performed by a second terminal device. The method comprises: determining, at a second terminal device, a successful transmission of a path switch configuration to a first terminal device, the first terminal device being connected to a first network device via a relaying path comprising the second terminal device and being switched to a target path between the first terminal device and a second network device; and performing one of the following: transmitting, to the first network device, a first message indicating the successful transmission of the path switch configuration to the first terminal device; or applying a previously-received second message used for re-configuring the relaying path.

In a fourth aspect, there is provided a method performed by a first terminal device. The method comprises: detecting, at a first terminal device and via a keep-alive procedure, a failure of a PC5 path between the first terminal device and a second terminal device without receiving a path switch configuration from the second terminal device, the first terminal device being connected to a first network device via the second terminal device; and initiating a re-establishment procedure with the second terminal device.

In a fifth aspect, there is provided a method performed by a core network (CN) device. The method comprises: generating, at a CN device, a first message explicitly or implicitly indicating a successful transmission of a path switch configuration to a first terminal device, the first terminal device being connected to a first network device via a relaying path comprising a second terminal device and being switched to a target path between the first device and a second network device; and transmitting the first message to the first network device.

In a sixth aspect, there is provided a first network device. The first network device includes a processing unit; and a memory coupled to the processing unit and storing instructions thereon, the instructions, when executed by the processing unit, causing the device to perform the method according to the first aspect.

In a seventh aspect, there is provided a second network device. The second network device includes a processing unit; and a memory coupled to the processing unit and storing instructions thereon, the instructions, when executed by the processing unit, causing the device to perform the method according to the second aspect.

In an eighth aspect, there is provided a second terminal device. The second terminal device includes a processing unit; and a memory coupled to the processing unit and storing instructions thereon, the instructions, when executed by the processing unit, causing the device to perform the method according to the third aspect.

In a ninth aspect, there is provided a first terminal device. The first terminal device includes a processing unit; and a memory coupled to the processing unit and storing instructions thereon, the instructions, when executed by the processing unit, causing the device to perform the method according to the fourth aspect.

In a tenth aspect, there is provided a CN device. The CN device includes a processing unit; and a memory coupled to the processing unit and storing instructions thereon, the instructions, when executed by the processing unit, causing the device to perform the method according to the fifth aspect.

In an eleventh aspect, there is provided a computer readable medium having instructions stored thereon, the instructions, when executed on at least one processor, causing the at least one processor to carry out the method according to any of the first to the fifth aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates a signaling chart illustrating a process for intra-gNB path switch in some embodiments;

FIG. 1B illustrates a signaling chart illustrating a process for inter-gNB path switch in some embodiments;

FIG. 1C illustrates another signaling chart illustrating a process for inter-gNB path switch in some embodiments;

FIG. 2A illustrates a block diagram of a communication environment in which embodiments of the present disclosure can be implemented;

FIG. 2B illustrates a signaling chart illustrating a process for communication according to some embodiments of the present disclosure;

FIG. 2C illustrates anther block diagram of a communication environment in which embodiments of the present disclosure can be implemented;

FIG. 3 illustrates a signaling chart illustrating a process for communication according to some embodiments of the present disclosure;

FIGS. 4A to 4F illustrate signaling charts illustrating processes for communication according to some embodiments of the present disclosure;

FIGS. 5A and 5B illustrate signaling charts illustrating processes for communication according to some embodiments of the present disclosure;

FIG. 6 illustrates an example method of communication implemented at a first network device in accordance with some embodiments of the present disclosure;

FIG. 7 illustrates an example method of communication implemented at a second network device in accordance with some embodiments of the present disclosure;

FIG. 8 illustrates an example method of communication implemented at a second terminal device in accordance with some embodiments of the present disclosure;

FIG. 9 illustrates an example method of communication implemented at a first terminal device in accordance with some embodiments of the present disclosure;

FIG. 10 illustrates an example method of communication implemented at a CN device in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the wireless communication network, a terminal device may communicate with the network via a direct network connection or an indirect network connection. Further, in case of path switch, the communication path of the terminal device may be switched from a source network device to a target network device. In some embodiments, the source network device and the target network device are located in a same physical device (referred to as intra-gNB). Alternatively, in some other embodiments, the source network device and the target network device are located in different physical devices (referred to as inter-gNB).

In view of the above, a path switch maybe associated with any of: indirect-to-direct (I2D) path switch for intra-gNB, indirect-to-indirect (I2I) path switch for intra-gNB, direct-to-direct (D2D) path switch for intra-gNB, direct-to-indirect (D2I) path switch for intra-gNB, I2D for inter-gNB, I2I for inter-gNB, D2D for inter-gNB and D2I for inter-gNB.

As discussed above, generally speaking, during a path switch, in case that the source path is an indirect path, the release of source path should be performed after a successful transmission of a path switch command to the terminal device.

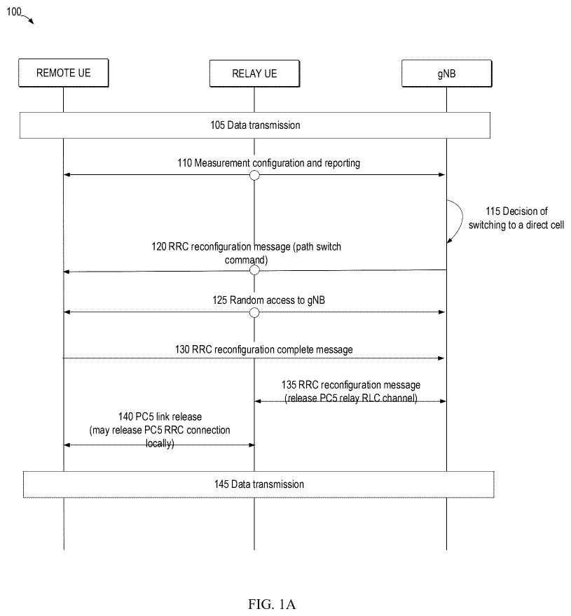

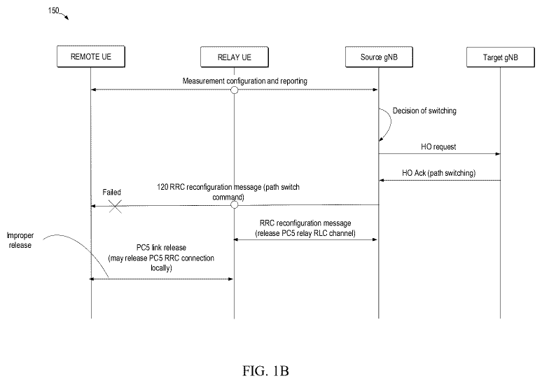

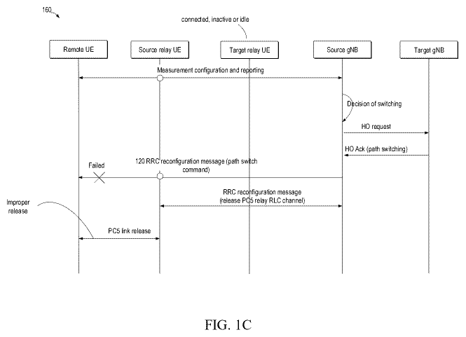

FIG. 1A illustrates a signaling chart illustrating a process 100 for intra-gNB path switch in some embodiments. As illustrated in FIG. 1A, the remote UE originally performs 105 data transmission with the gNB via the relay UE. Then, an Uu measurement configuration and measurement report procedures are performed 110 to evaluate both of the relay link measurement and Uu link measurement. Specifically, the measurement results from layer 2 (L2) user to network (U2N) remote UE are reported when configured measurement reporting criteria are met. In some embodiments, the sidelink relay measurement report may include at least one of: source L2 identify (ID) of the L2 U2N relay UE, serving cell ID (i.e., NR cell global identifier, NCGI, or NR cell identifier, NCI), and sidelink measurement quantity result. The sidelink measurement quantity may be sidelink (SL)-reference signal receiving power (RSRP) of the serving L2 U2N relay UE, and if SL-RSRP is not available, sidelink discovery (SD)-RSRP is used. By using the measurement result, the gNB decides 115 to switch the L2 U2N remote UE onto a direct Uu path.

Next, the gNB sends 120 radio resource control (RRC) reconfiguration message to the L2 U2N remote UE. The L2 U2N remote UE stops uplink (UP) and control plane (CP) transmission via L2 U2N relay UE after reception of RRC reconfiguration message with the path switch configuration from the gNB. In response to the RRC reconfiguration message, the L2 U2N remote UE synchronizes with the gNB and performs 125 random access (RA) with the gNB.

After that, the UE (i.e., the L2 U2N remote UE in previous steps) sends 130 the RRC reconfiguration complete message to the gNB via the established direct path, using the configuration provided in the RRC reconfiguration message. From this step, the UE (i.e., L2 U2N remote UE in previous steps) uses the RRC connection via the direct path to the gNB. The gNB sends 135 an RRC reconfiguration message to the L2 U2N relay UE to reconfigure the connection between the L2 U2N relay UE and the gNB.

In the specific embodiments, the RRC reconfiguration message to the L2 U2N relay UE can be sent any time after sending 120 RRC reconfiguration message based on the gNB implementation (e.g., to release Uu and PC5 relay RLC channel configuration for relaying, and bearer mapping configuration related to the L2 U2N remote UE).

Either the L2 U2N Relay UE or the L2 U2N Remote UE's AS layer can release 140 the PC5-RRC connection and indicates upper layer to release PC5 unicast link after receiving RRCReconfiguration message from the gNB. The timing to execute link release is up to UE implementation. Next, the data path is switched from indirect path to direct path between the UE (i.e., previous L2 U2N Remote UE) and the gNB. The packet data convergence protocol (PDCP) re-establishment or PDCP data recovery in UL is performed 145 by the UE (i.e., previous L2 U2N remote UE) for lossless delivery during path switch if gNB configures it.

In the specific embodiments of FIG. 1A, since the source gNB also act as the target gNB, the source gNB can reconfigure the relay UE to release the PC5 relay RLC channel properly after receiving the RRC reconfiguration complete message from remote UE which means a successful transmission of a path switch command. In this way, it is ensured that the PC5 relay RLC channel is released (or the PC5 link is released, initiated by the relay UE) after the successful transmission of path switching command.

For the inter-gNB case, the remote UE will access to the target gNB rather than the source gNB, while the release of the relay RLC channel/reconfiguration of relay UE is controlled by the source gNB. Thus, in case of inter-gNB and the source path is a relaying path, the source network device does not know whether the path switch command has been transmitted successfully. Reference is now made to FIG. 1B and FIG. 1C, which illustrate signaling chart illustrating processes 150 and 160 for inter-gNB path switch in some embodiments.

As illustrated in FIG. 1B and FIG. 1C, in case of a failure transmission of path switch command, an improper PC5 connection may be triggered. In other words, the PC5 relay RLC channel/the PC5 link may be released (e.g. initiated by the relay UE) before the successful transmission of the path switching command, which is an unexpected result. For example, without the successful transmission of the path switching command, the remote UE cannot trigger to establish a new connection with the target network device, however the source connection has been released, which means that the communication of the remote UE will be interrupted. In addition, as the source connection has been released, the source network device also cannot retransmit the path switching command to the remote UE again, which causes that the connection state information at the remote UE is not consistent with that at the source network side. Thus, in case of inter-gNB, how to control the release of the relaying path during a path switch needs to be further discussed. In other words, the timing of the successful transmission of the path switching command and releasing the relaying should be ruled.

Embodiments of the present disclosure provide a solution for path switch. In the present disclosure, a successful transmission of a path switch configuration to the terminal device may be determined and/or informed to the source network device and/or the relay terminal device. As for the source network device, the source network device may generate a second message used for re-configuring the relaying path in response to the successful transmission of the path switch configuration. Alternatively, or in addition, the relay terminal device may apply the path switch configuration until the successful transmission of the path switch configuration.

In this way, it is ensured that the relay path may be released after the successful transmission of the path switch configuration. As a result, the communication continuity of the remote UE is guaranteed.

For ease of discussion, some terms used in the following description are listed as below:
A direct network connection: refers to one mode of network connection, where there is no relay terminal device/relay UE between a terminal device and the network device; also referred to as a direct path sometime.
An indirect network connection: refers to one mode of network connection, where there is a relay terminal device/relay UE between a terminal device and the network device; also referred to as a relaying path or indirect path sometimes.
A first network device: refers to a network entity, which may be source network device during a path switch.
A second network device: refers to a network entity, which may be target network device during a path switch.
A first terminal device, refers to a terminal entity to be switched. In some embodiments, the first terminal device is originally connected to the first network device via a relaying path (also referred to as a source path). Further, the first terminal device is to be switched to a target path, such that the first terminal device may be connected to the second network device. In some embodiments, the target path is a direct path. Alternatively, in some other embodiments, the target path is an indirect path; the first terminal device is also referred to as a remote terminal device sometimes.
A second terminal device, refers to a terminal entity, functioning as a relay terminal device in the source path; also referred to as a source relay terminal device sometimes.
A further second terminal device, refers to a terminal entity, functioning as a relay terminal device in the target path; also referred to as a target relay terminal device sometimes.
A relaying path: refers to any of the following: a path between a network device and a remote terminal device via a relay terminal device or multiple relay terminal devices, a path between a remote terminal device and a relay terminal device (i.e., a PC5 connection/sidelink connection/D2D connection), or a path between a relay terminal device and a network device.
successful transmission of path switch configuration/command: refers to any of the following: the path switch configuration/command having been successfully received by the terminal device, a successful completion of the path switch to the second network device/target device, a successful accession to the second network device/target device, or a success/completion of path switching to the second network device/target device.

In the present discourse, terms “a path switch configuration”, “a path switch command”, “an RRC reconfiguration with path switch command”, “an RRC reconfiguration for path switching” may be used interchangeably; terms “path switch”, “path switching” may be used interchangeably; terms “relay path”, “relaying path” may be used interchangeably.

In some embodiments, message/signaling “HO command” are used for I2D scenario and message/signaling “path switching” are used for I2I scenario.

Principles and implementations of the present disclosure will be described in detail below with reference to the figures.

### Example of Communication Network

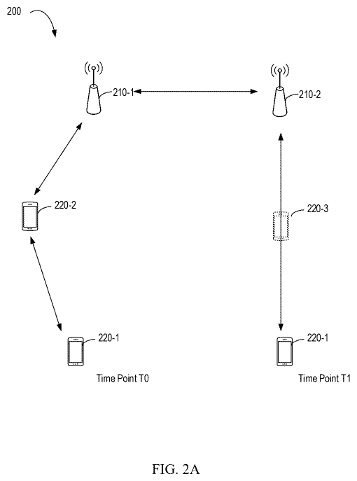

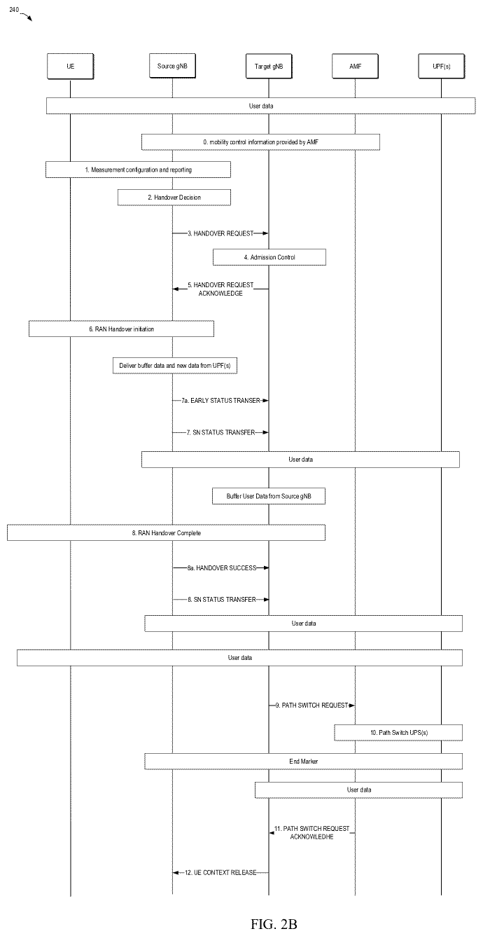

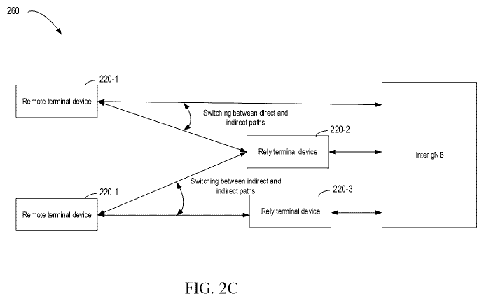

FIG. 2A shows an example communication environment 200 in which example embodiments of the present disclosure can be implemented. The communication environment 200 comprises a plurality of terminal devices and network devices. As shown in the FIG. 2A, the communication environment 200 comprises a network device 210-1, a network device 210-2. For purpose of discussion, the network devices 210-1 and 210-2 are collectively referred to as network device 210, or individually refers to as the first network device 210-1 (i.e., referred to as source gNB sometimes) and the second network device 210-2 (i.e., referred to as target gNB sometimes), respectively.

In the specific example embodiment of FIG. 2A, the first network device 210-1 and the second network device 220-2 are located in different physical devices, and thus the inter-gNB network structure is supported in the communication environment 200.

The communication environment 200 further comprises a terminal device 220-1, a terminal device 220-2 and a terminal device 220-3. At time point T0, the terminal device 220-1 communicates with the first network device 210-1 via the terminal device 220-2, i.e., via an indirect path/relaying path. In the following, the terminal device 220-1 may move over time or the channel condition of the terminal device 220-1 may become worse, which causes that the connection between the terminal device 220-1 and the network device 210-1 need to be changed, for example, the terminal device 220-1 may be switched to another path (also referred to as a target path).

In the specific example embodiment of FIG. 2A, at time point T1, the terminal device 220-1 may be switched to a target path with the second network device 210-2. In some embodiments, the target path is a direct path, i.e., the terminal device 210-1 communicates with the second network device 210-2 directly. Alternatively, in some other embodiments, the target path is an indirect path, i.e., the terminal device 210-1 communicates with the network device 210-2 via the terminal device 220-3.

FIG. 2B illustrates a signaling chart illustrating process 240 for communication according to some embodiments of the present disclosure.

As illustrated in FIG. 2B, the source gNB issues a Handover Request message to the target gNB passing a transparent RRC container with necessary information to prepare the handover at the target side. The information includes at least the target cell ID, KgNB*, the cell-radio network temporary identity (C-RNTI) of the UE in the source gNB, radio resource management (RRM)-configuration including UE inactive time, basic AS-configuration including antenna information and downlink (DL) carrier frequency, the current quality of service (QoS) flow to DRB mapping rules applied to the UE, the signaling radio bearer 1 (SRB1) from source gNB, the UE capabilities for different RATs, protocol data unit (PDU) session related information, and can include the UE reported measurement information including beam-related information if available. The PDU session related information includes the slice information and QoS flow level QoS profile(s). The source gNB may also request a dual active protocol stack (DAPS) handover for one or more data radio bearers (DRBs).

In some embodiments, an admission control may be performed by the target gNB. Slice-aware admission control shall be performed if the slice information is sent to the target gNB. If the PDU sessions are associated with non-supported slices the target gNB shall reject such PDU Sessions.

In some embodiments, the target gNB prepares the handover with layer 1 (L1)/L2 and sends the HANDOVER REQUEST ACKNOWLEDGE to the source gNB, which includes a transparent container to be sent to the UE as an RRC message to perform the handover. The target gNB also indicates if a DAPS handover is accepted.

In some embodiments, the source gNB triggers the Uu handover by sending an RRCReconfiguration message to the UE, containing the information required to access the target cell: at least the target cell ID, the new C-RNTI, the target gNB security algorithm identifiers for the selected security algorithms. It can also include a set of dedicated RACH resources, the association between random access channel (RACH) resources and synchronization signal and PBCH block, SSB(s), the association between RACH resources and UE-specific channel state information (CSI)-reference signal (RS) configuration(s), common RACH resources, and system information of the target cell, etc.

In some embodiments, the UE synchronizes to the target cell and completes the RRC handover procedure by sending RRCReconfigurationComplete message to target gNB. In case of DAPS handover, the UE does not detach from the source cell upon receiving the RRCReconfiguration message. The UE releases the source resources and configurations and stops DL/UL reception/transmission with the source upon receiving an explicit release from the target node.

In some embodiments, in case of DAPS handover, the target gNB sends the HANDOVER SUCCESS message to the source gNB to inform that the UE has successfully accessed the target cell. In return, the source gNB sends the SN STATUS TRANSFER message for DRBs configured with DAPS.

In some embodiments, 5GC (such as, access and mobility management function, AMF, or user plane function, UPF) switches the DL data path towards the target gNB. The UPF sends one or more “end marker” packets on the old path to the source gNB per PDU session/tunnel and then can release any U-plane/TNL resources towards the source gNB.

In some embodiments, upon reception of the PATH SWITCH REQUEST ACKNOWLEDGE message from the AMF, the target gNB sends the UE CONTEXT RELEASE to inform the source gNB about the success of the handover. The source gNB can then release radio and C-plane related resources associated to the UE context. Any ongoing data forwarding may continue.

Reference is now made to FIG. 2C, which illustrates another example communication environment 260. As illustrated in FIG. 2C, a path switch may be performed between the direct and indirect paths, i.e., I2D and D2I, and also may be performed between the indirect and indirect paths, i.e. I2I.

It is to be understood that the number of devices and cells in FIG. 2A to FIG. 2C are given for the purpose of illustration without suggesting any limitations to the present disclosure. The communication network may include any suitable number of network devices and/or terminal devices adapted for implementing implementations of the present disclosure.

In some embodiments, the terminal device 220 and the network device 210 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

### Example Processed for Path Switch

It should be understood that although feature(s)/operation(s) are discussed in specific example embodiments separately, unless clearly indicated to the contrary, these feature(s)/operation(s) described in different example embodiments may be used in any suitable combination.

In addition, in the following description, some interactions are performed among the terminal device 220 and the network device 210 (such as, exchanging configuration(s) and so on). It is to be understood that the interactions may be implemented either in one single signaling/message or multiple signaling/messages, including system information, radio resource control (RRC) message, downlink control information (DCI) message, uplink control information (UCI) message, media access control (MAC) control element (CE), sidelink relay adaptation protocol (SRAP) and so on. The present disclosure is not limited in this regard.

In the following, some example embodiments will be discussed for the scenario of I2D. It is be understood that the scenario of I2D is merely for the purpose of illustration without suggesting any limitations. That is, the example embodiments discussed for I2D are also suitable for the scenario of I2I. Merely for brevity, the same or similar content are omitted.

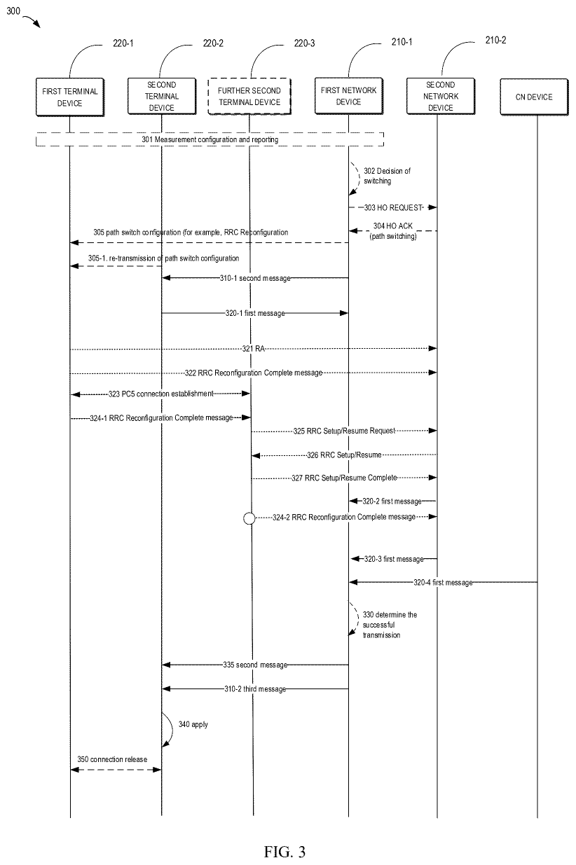

Principle and implementations of the present disclosure will be described in detail below with reference to FIG. 3, which shows a signaling chart illustrating a process 300 of communication according to some example embodiments of the present disclosure. For the purpose of discussion, the process 300 will be described with reference to FIGS. 2A to 2C.

The process 300 may involve the first network device 210-1 (i.e., a source network device), the second network device 210-2 (i.e., a target network device), the first terminal device 220-1 (i.e., a remote terminal device), the second terminal device 220-2 (i.e., a source relay terminal device) and a CN device. Further, the process 300 may optionally involve a further second terminal device 220-3 (i.e., a target relay terminal device).

In the specific embodiment of FIG. 3, the first terminal device 220-1 originally connected with the first network device 210-1 via a second terminal device 220-2.

In operation, the first terminal device 220-1 optionally may be configured 301 to measure and report the measurement results. Based on the measurement results, the first network device 210-1 may determine 302 to perform a path switch. In the following, the first network device 210-1 transmits 303 a handover (HO) request to the second network device 210-2 and receives 304 an HO acknowledge (ACK) from the second network device 210-2.

In some embodiment, the target path during the path switch is either a direct path or an indirect path.

In some embodiment, the first network device 210-1 transmits 305 a path switch configuration (for example, an RRC reconfiguration for path switching) to the first terminal device. However, the transmission of the path switch configuration may be failed sometimes. If so, the re-transmission of path switch configuration 305-1 is needed, and the re-transmission of the path switch configuration requires that the PC5 connection between the first terminal device 220-1 and the second terminal device 220-2.

In some embodiment, the path switch configuration is associated with an I2D path switching or an I2I path switching.

In some embodiment, the path switch configuration is associated with an inter-gNB path switching.

According to some embodiments of the present discourse, the release of the relay path (including any of a connection between the first terminal device 220-1 and the second terminal device 220-2, a connection between the first terminal device 220-1 and the first network device 210-1, and a connection between the second terminal device 220-2 and the first network device 210-1) may be controlled. In particular, the release of the relay path may be performed after a successful transmission of the path switch configuration.

In some embodiments, the first network device 210-1 may transmits a second message used for re-configuring the relaying path to the second terminal device 220-2, where the second message may trigger a release of the relay path at the second terminal device 220-2. In view of this, the transmission occasion of the second message may be controlled. As a general rule, the first network device 210-1 controls the transmission of the second message to be performed after the successful transmission of the path switch configuration to the first terminal device 220-1. In other words, the first network device 210-1 controls the transmission of the second message to be performed after the successful completion of the path switch or successful accession to the second network device 210-2 by the first terminal device 220-1. Some example processes are discussed as below.

In some embodiments, the first network device 210-1 receives a first message indicating a successful transmission of a path switch configuration to a first terminal device 220-1, and then transmits 335 the second message used for re-configuring the relaying path to the second terminal device 220-2. As a result, the PC5 connection between the first terminal device 220-1 and the second terminal device 220-2 may be released 350.

In some embodiments, the first message may indicate the successful transmission of a path switch configuration in an explicit manner. Specifically, the first message comprises an indication indicating the successful transmission of the path switch configuration to the first terminal device.

Alternatively, in some other embodiments, the first message may indicate the successful transmission of the path switch configuration in an implicit manner. Specifically, some existing signalings may be reused for indicating the successful transmission. Additionally, when reusing the existing signalings, the existing signalings also may comprise an explicit indication which indicates the successful transmission of the path switch configuration.

Furter, in some embodiments, the first message may be received from any of the second network device 210-2, the second terminal device 220-2 or the CN device. The detailed description will be discussed as below.

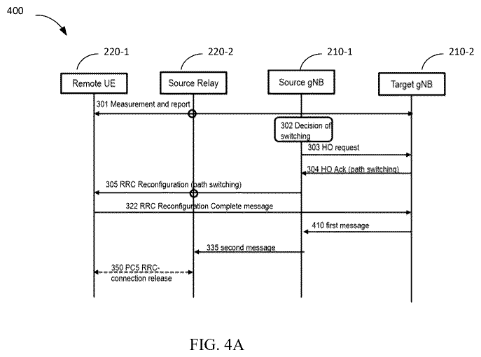

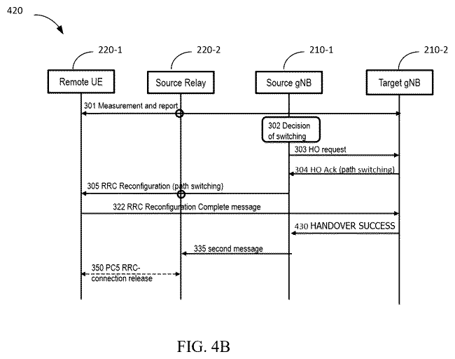

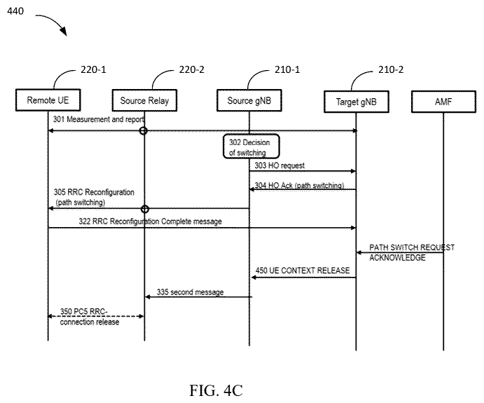

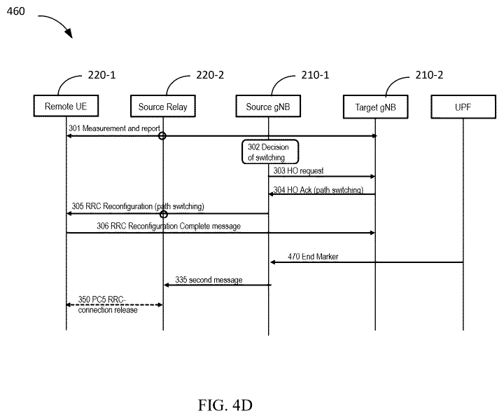

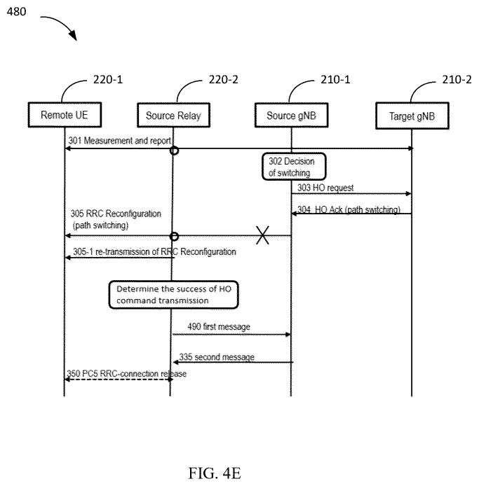

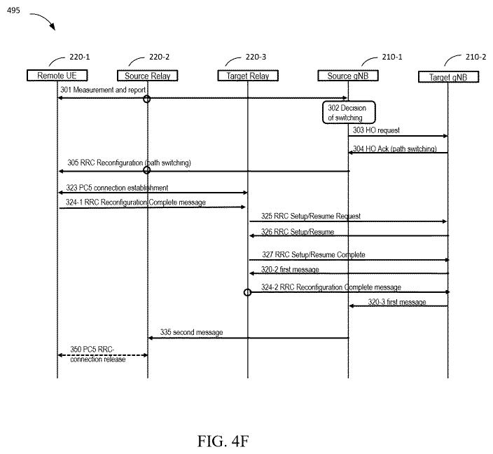

As illustrated in FIG. 3, in some embodiments, the first message is received 320-3 from the second network device 210-2. For better understanding, reference is now made to FIG. 4A, which shows a signaling chart illustrating a process 400 of communication according to some example embodiments of the present disclosure. For the purpose of discussion, the process 400 will be described with reference to FIG. 3. That is, the same references in FIG. 3 and FIG. 4A refer to the same physical meanings.

In some embodiments, after receiving a fourth message about the successful transmission of the path switch configuration (or a success handover), the second network device 220-2 sends 410 the first message to the first network device 210-1, where the first message may indicate the success of (sidelink relay) path switching (i.e., successful transmission of the path switch configuration).

Additionally, in some embodiments, the second message is transmitted only in case of I2D/I2I path switching scenario.

As illustrated in FIG. 4A, upon receiving the first message, the first network device 210-1 may determine the successful accession to the target cell of the first terminal device 210 or the success of path switching, and then the first network device 210-1 may send 335 an second message (such as, RRCReconfiguration message) to the second terminal device 220-2 to reconfigure the relaying path (such as, the connection between the second terminal device 220-2 and the first network device 210-1 and/or the connection between the second terminal device 220-2 and the first terminal device 220-1, for example, to release the PC5 Relay RLC channel).

Additionally, in some embodiments, the second network device 210-2 may be notified by the first network device 210-1 that the first terminal device 220-1 was connected to the first network device 210-1 via an indirect path before the path switching.

Further, in perspective of the second network device 210-2, the successful transmission of the path switch configuration may be implied/determined after receiving a fourth message from a further device. For one example, the second network device 210-2 receives 322 an RRC reconfiguration complete message from the first terminal device 220-1, where the RRC reconfiguration complete message is transmitted in response to random access (RA) 321 procedure of the second network device 210-2. For another example, the second network device 210-2 receives a PATH SWITCH REQUEST ACKNOWLEDGE from the CN device (such as, AMF).

In some embodiments, the target path is either a direct path or an indirect path. As illustrated in FIG. 3, in case that the target path is an indirect path, the PC5 connection is established 323 between the first terminal device 220-1 and a further second terminal device 220-3 (i.e., the target relay terminal device). After that, the first terminal device 220-1 transmits 324-1 an RRC Reconfiguration complete message to the further second terminal device 220-3, then the RRC Reconfiguration Complete message may be forwarded 324-2 to the second network device 210-2. As discussed above, the forwarded RRC Reconfiguration complete message may be used as the fourth message.

Additionally, in case that the further second terminal device 220-3 is in an idle or inactive state, after receiving the RRC reconfiguration complete message from the first terminal device 220-1, the further second terminal device 220-3 transmits 325 an RRC Setup/Resume request to the second network device 210-2. Then, the further second terminal device 220-3 receives 326 an RRC Setup/Resume message from the second network device 210-1, and then an RRC Setup/Resume complete may be transmitted 327 to the second network device 210-2. In view of the this, in case that the further second terminal device 220-3 is in an idle or inactive state, the fourth message may be one of the following:
an RRC setup request received from the further second terminal device,
an RRC resume request received from the further second terminal device,
an RRC setup complete received from the further second terminal device, or
an RRC resume complete received from the further second terminal device.

In this event, as illustrated in FIG. 3, the second network device 210-2 may transmit 320-2 the first message to first network device to indicate the successful transmission of a path switch configuration. That is, the second network device 210-2 uses the accession of the target relay UE (i.e., the further second terminal device 220-3) as a trigger for sending the first message. In this event, the first message may be transmitted via a newly-defined Xn message. Additionally, the first message may be send in case of I2D path switching and/or I2I path switching.

For better understanding, reference is now made to FIG. 4F, which shows a signaling chart illustrating a process 495 of communication according to some example embodiments of the present disclosure, where the target path is an indirect path and the target relay terminal device (i.e., the further second terminal device 220-3) is in an idle or inactive state.

Further, as discussed above, some existing signaling may be reused for indicating the successful transmission. In some embodiment, after receiving an RRC Reconfiguration complete message from the first terminal device 220-1, the second network device 210-2 may transmit a handover success (HANDOVER SUCCESS) message to the first network device 210-1. In view of this, the handover success message may be reused as the first message, because the handover success message may imply the successful transmission of a path switch configuration. Additionally, in case of I2D/I2I path switching, the first network device 210-1 can then send 335 the second message to the first terminal device 220-1.

In some embodiments, the handover success message itself implies the successful transmission of the path switch configuration. Alternatively, in some other embodiments, the handover success message comprises an explicit indication which indicates the successful transmission of the path switch configuration.

For better understanding, reference is now made to FIG. 4B, which shows a signaling chart illustrating a process 420 of communication according to some example embodiments of the present disclosure. As illustrated in FIG. 4B, the second network device 210-2 transmits the HANDOVER SUCCESS to the first network device 210-1 to indicate the successful transmission of a path switch configuration.

In summary, the remote UE (i.e., the first terminal device 220-1) synchronizes to the target cell and completes the RRC handover procedure by sending RRCReconfigurationComplete message to target gNB (i.e., the second network device 210-2). In case of DAPS handover, the target gNB sends the HANDOVER SUCCESS message to the source gNB (i.e., the first network device 210-1) to inform that the UE (i.e., the first terminal device 220-1) has successfully accessed the target cell. In return, the source gNB sends the SN STATUS TRANSFER message for DRBs configured with DAPS. In case of I2D path switching or I2I path switching, the target gNB sends the HANDOVER SUCCESS message to the source gNB to inform that the UE has successfully accessed the target cell. Upon the HANDOVER SUCCESS message, the source gNB sends an RRCReconfiguration message (i.e., the second message) to relay UE (i.e., the second terminal device 220-2), for example, to release the PC5 Relay RLC channel.

In this way, the PC5 relay RLC channel or PC5 connection may be released at an appropriate occasion, and further the resources of relay UE can be released timely. Moreover, the signaling interaction is performed with a low complexity.

Alternatively, as illustrated in FIG. 2B, in some embodiment, upon receiving the SN STATUS TRANSFER message from the first network device 210-1, the second network device 210-2 may transmit a PATH SWITCH REQUEST to the CN device (such as, AMF). Upon the PATH SWITCH REQUEST, the CN device may transmit a PATH SWITCH REQUEST ACKNOWLEDGE to the second network device 210-2. Then the second network device 210-2 may transmit a UE context release message to the first network device 210-1. In view of this, the UE context release message (UE CONTEXT RELEASE) may be reused as the first message, because the UE context release message also may imply the successful transmission of a path switch configuration. Additionally, in case of I2D/I2I path switching, the first network device 210-1 can then send 335 the second message to the first terminal device 220-1.

In some embodiments, the UE context release message itself implies the successful transmission of the path switch configuration. Alternatively, in some other embodiments, the UE context release message comprises an explicit indication which indicates the successful transmission of the path switch configuration.

For better understanding, reference is now made to FIG. 4C, which shows a signaling chart illustrating a process 440 of communication according to some example embodiments of the present disclosure. As illustrated in FIG. 4C, the second network device 210-2 transmits the UE CONTEXT RELEASE to the first network device 210-1 to indicate the successful transmission of a path switch configuration.

In summary, upon reception of the PATH SWITCH REQUEST ACKNOWLEDGE message from the CN device (such as, AMF), the target gNB (i.e., the second network device 210-2) sends the UE CONTEXT RELEASE to inform the source gNB (i.e., the first terminal device 220-1) about the success of the handover. The source gNB can then release radio and C-plane related resources associated to the UE context. In case of I2D/I2I path switching, the source gNB can then send an RRCReconfiguration message (i.e., the second message) to the relay UE (i.e., the second terminal device 220-2), for example, to release the PC5 Relay RLC channel. Any ongoing data forwarding may continue.

In this way, the PC5 relay RLC channel may be released at an appropriate occasion, and the signaling interaction is performed with a low complexity.

In some embodiments, the timing of configuring the second terminal device 220-2 for inter-gNB D2I/I2I path switching is ruled as: the configuration of the second terminal device 220-2 for inter-gNB path switching can be sent at any time after the source gNB (i.e., the first network device 210-1) receiving a first message (e.g. a UE CONTEXT RELEASE) or a first message comprising an explicit indication indicating the successful transmission of the path switch configuration to the first network device 210-1 (e.g. a UE CONTEXT RELEASE comprising an explicit indication). In other words, the first message itself implies the successful transmission of the path switch configuration, or the first message comprises an explicit indication which indicates the successful transmission of the path switch configuration.

Alternatively, in some other embodiments, the timing of configuring the second terminal device 220-2 for inter-gNB D2I/I2I path switching is ruled as: the configuration of the second terminal device 220-2 for inter-gNB path switching can be sent at any time after the UE (i.e., the first terminal device 210-1) sending the RRCReconfigurationComplete message to the target gNB (i.e., the second network device 210-2).

Alternatively, in addition to receiving the first message from the second network device 210-2, the first network device 210-1 also may receive 320-4 the first message from the CN device.

In some specific embodiments, the CN device may transmit a first message or a first message comprising an explicit indication indicating the successful transmission of the path switch configuration to the first network device 210-1. In other words, the first message itself implies the successful transmission of the path switch configuration, or the first message comprises an explicit indication which indicates the successful transmission of the path switch configuration.

Further, similar with the second network device 210-2, the CN device also may reuse some existing signalings as the first message.

As illustrated in FIG. 2B, in some embodiment, upon receiving the PATH SWITCH REQUEST from the second terminal device, the AMF and the UPF(s) may perform the path switch in UPFs. As a result, the UPF(s) will transmit end marker packet(s) to the first network device 210-1. In view of this, the end marker packet(s) may be reused as the first message, because the end marker packet(s) may imply the successful transmission of a path switch configuration.

For better understanding, reference is now made to FIG. 4D, which shows a signaling chart illustrating a process 460 of communication according to some example embodiments of the present disclosure. As illustrated in FIG. 4D, the CN device transmits the end marker packet to the first network device 210-1 to indicate the successful transmission of a path switch configuration.

Additionally, in some embodiments, the source gNB determines the success of path switching if at least one “end marker” packet of each PDU session/tunnel has been received from the UPF(s), which means that all the related PDU sessions/tunnels have been switched at the CN.

Alternatively, in some embodiments, the source gNB determines the success of path switching if at least one “end marker” packet of at least one PDU session/tunnel has been received from the UPF(s), which means that at least part of the PDU sessions/tunnels have been switched at the CN.

In summary, in some embodiments, the core network (including AMF and UPF) switches the DL data path towards the target gNB (i.e., the second network device 210-2). The UPF sends one or more “end marker” packets on the old path to the source gNB (i.e., the first network device 210-1) per PDU session/tunnel and then can release any U-plane/TNL resources towards the source gNB. The source gNB determines the success of path switching if at least one “end marker” packet of each PDU session/tunnel have been received by it, and then sends an RRCReconfiguration message to Relay UE (i.e., the second terminal device 220-2), for example, to release the PC5 Relay RLC channel. In this way, the PC5 relay RLC channel may be released at an appropriate occasion.

Alternatively, the first network device 210-1 also may receive 320-1 the first message from the second terminal device 220-2. For example, the second terminal device 220-2 may send a first message of a first message comprise an explicit indication indicating the successful transmission of path switch configuration to trigger the first network device 210-1 to send the second message (i.e., a RRC reconfiguration message) . In other words, the first message itself implies the successful transmission of the path switch configuration, or the first message comprises an explicit indication which indicates the successful transmission of the path switch configuration.

For better understanding, reference is now made to FIG. 4E, which shows a signaling chart illustrating a process 480 of communication according to some example embodiments of the present disclosure. As illustrated in FIG. 4E, in case of a successful transmission of a path switch configuration, the second terminal device 220-2 transmits 490 the first message to the first network device 210-1 to indicate the successful transmission of a path switch configuration.

Additionally, in some embodiments, the second terminal device 220-2 transmits the first message via a MAC CE or RRC signaling (such as, sidelink UE information, Sidelink UEInformationNR message, or UE assistance information).

In perspective of the second terminal device 220, a plurality of factors of may be used for determining the successful transmission of a path switch configuration. Example factors include but are not limited to,
Factor #1: the last packet data unit (PDU) for a PC5 radio link control (RLC) channel corresponding to an SRB (including at least one of SIB1, SIB2, SIB3, or controlling signaling) associated with the first terminal device is transmitted to the first terminal device 220-1 successfully. In other words, the last RLC PDU for the PC5 relay RLC channel of/corresponding to Uu RRC signaling/SRB1 has been transmitted successfully.
Factor #2: an acknowledge for the last RLC PDU for a PC5 radio link control (RLC) channel corresponding to an SRB (including at least one of SIB1, SIB2, SIB3, or controlling signaling) associated with the first terminal device is received from the first terminal device. In other words, a PC5 RLC ack is received for the last RLC PDU of the PC5 relay RLC channel of Uu RRC signaling/SRB1 from the remote UE (i.e., the first terminal device 220-1).
Factor #3: there is no packet buffered for a PC5 RLC channel corresponding to an SRB (including at least one of SIB1, SIB2, SIB3, or controlling signaling) associated with the first terminal device 220-1. In other words, the buffer for the PC5 Relay RLC channel of Uu RRC signaling/SRB1 is empty.
Factor #4: a time length without receiving a packet for a PC5 radio link control (RLC) channel corresponding to an SRB (including at least one of SIB1, SIB2, SIB3, or controlling signaling) associated with the first terminal device reaches a pre-configured time length. In other words, no data/packet has arrived during a pre-defined period for the PC5 relay RLC channel of Uu RRC signaling/SRB1. Additionally, the pre-configured time length or the pre-defined period is configured as a default value or configured by one of the following: system information, an RRC signaling, a MAC CE or downlink control information (DCI).
Factor #5: the second terminal device is indicated by an upper layer about a release of a PC5 connection for the first terminal device, where the release of a PC5 connection may refer to either the PC5 connection having been released or the PC5 connection being to be released.
Factor #6: receiving a third message used for triggering the second terminal device to apply a previously-received second message from the first network device.

Additionally, factor #1 and factor #3 may be used together when determining the successful transmission of the path switch configuration. Alternatively, factor #1 and factor #4 may be used together when determining the successful transmission of the path switch configuration. Alternatively, factor #2 and factor #3 may be used together when determining the successful transmission of the path switch configuration. Alternatively, factor #2 and factor #4 may be used together when determining the successful transmission of the path switch configuration.

It should be appreciated that the above example factors and their combinations are given for the purpose of illustration without suggesting any limitations. Further, the above factors and the other suitable factors may be used separately or in combination.

In order to ensuring that the relay path is released properly, except controlling the transmission occasion of the second message, the applying occasion of the second message also may achieve the same technical effects.

As illustrated in FIG. 3, after transmitting 305 the path switch configuration (such as, an RRC reconfiguration) to the first terminal device 220-1, the first network device 210-1 transmits 310-1 the second message for re-configuring the relaying path to the second terminal device 220-2 (such as, the connection between the second terminal device 220-2 and the first network device 210-1 and/or the connection between the second terminal device 220-2 and the first terminal device 220-1, for example, to release the PC5 Relay RLC channel). As for the second terminal device 220-2, the second terminal device 220-2 stores the second message without applying the second message or stores part of the second message (e.g. the part related to the relaying path or the part related to release the PC5 relay RLC channel) without applying this part. Next, if the second terminal device 220-2 determines that the path switch configuration has been transmitted to the first terminal device 220-1 successfully, the second terminal device 220-2 may apply 340 the previously-received second message. Because how does the second terminal device 220-2 determine whether the path switch configuration has been transmitted to the first terminal device 220-1 successfully has been fully discussed in previous part of the present discourse, merely for brevity, same contents are omitted here.

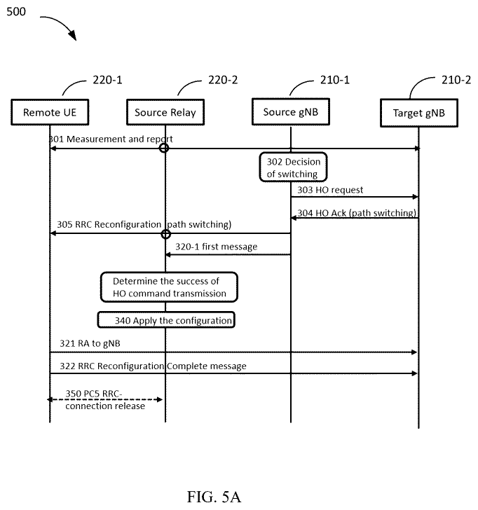

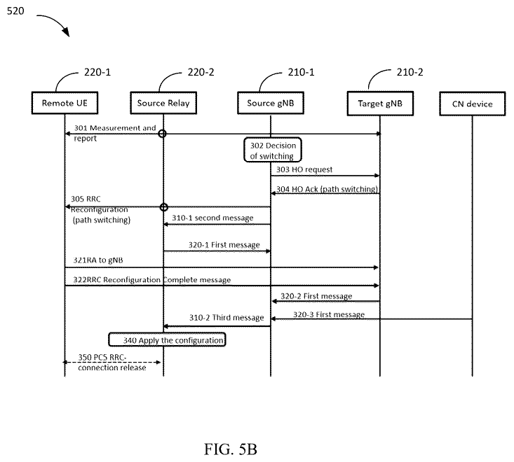

For better understanding, reference is now made to FIG. 5A, which shows a signaling chart illustrating a process 500 of communication according to some example embodiments of the present disclosure, where the second terminal device 220-2 determines that the path switch configuration has been transmitted to the first terminal device 220-1 successfully, and applies 340 the previously-received second message.

Further, applying the previously-received second message may be triggered by a third message from the first network device 210-1. As illustrated in FIG. 3, the first network device 210-1 determines 330 that that the path switch configuration has been transmitted to the first terminal device 220-1 successfully, and then transmits 310-2 a third message used for triggering the second terminal device 220-2 to apply a previously-received second message or the part of second message. Upon receiving the third message, the second terminal device 220-2 applies 340 the previously-received second message or the part of second message. Because how does the first network device 210-1 determine whether the path switch configuration has been transmitted to the first terminal device 220-1 successfully has been fully discussed in previous part of the present discourse, merely for brevity, same contents are omitted here.

For better understanding, reference is now made to FIG. 5B, which shows a signaling chart illustrating a process 500 of communication according to some example embodiments of the present disclosure, where upon receiving the third message, the second terminal device 220-2 determines that the path switch configuration has been transmitted to the first terminal device 220-1 successfully, and applies 340 the previously-received second message.

In some embodiments, the second terminal device 220-2 applies the previously-received second message by at least one of the following:
releasing the relaying path,
releasing a connection between the second terminal device 220-2 and the first network device 210-1,
releasing a connection between the second terminal device 220-2 and the first terminal device 220-1,
releasing at least one of PC5 Relay RLC channel, Uu Relay RLC channel and bearer mapping information,
releasing the PC5 channel, or
releasing the PC5-RRC connection.

In this way, the PC5 relay RLC channel may be released at an appropriate occasion without introducing too much signaling overhead.

The above example embodiments are mainly about how to avoid the improper release of the relay path. In the following text, example embodiments about how to handle the improper release of the relay path will be discussed.

In some embodiments, the first terminal device 220-1 may detect the relay connection failure, which is caused by the release of PC5 Relay RLC channel or the release of PC5-RRC connection by the second terminal device 220-2 locally based on at least one of the following:
Side link RLF, which will initiate RRC Re-establishment procedure for the second terminal device 220-2 in RRC_CONNECTED state, such as,
upon indication from sidelink RLC entity that the maximum number of retransmissions for a specific destination has been reached; or
upon indication from MAC entity that the maximum number of consecutive hybrid automatic repeat request (HARQ) discontinuous transmission (DTX) for a specific destination has been reached; or
Keep-alive procedure determines to release the PC5-RRC connection locally, such as, an expiry of timer T5080, or
the maximum number of allowed retransmissions of PROSE DIRECT LINK KEEPALIVE REQUEST message is reached.

In some embodiments, if the first terminal device 220-1 detects a failure of a PC5 path between the first terminal device 220-1 and a second terminal device 220-2 via a keep-alive procedure, the first terminal device 220-1 initiates a re-establishment procedure with the second terminal device 220-2.

In this way, the improper release of the relay path may be well handled.

### Example of Methods

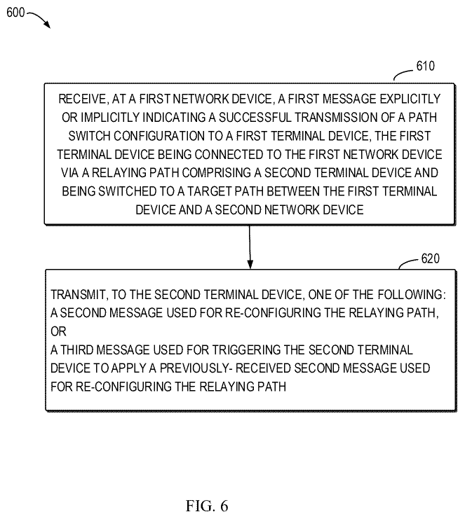

FIG. 6 illustrates a flowchart of an example method 600 in accordance with some embodiments of the present disclosure. For example, the method 600 can be implemented at the first network device 210-1 as shown in FIG. 2A.

At block 610, the first network device 210-1 receives a first message explicitly or implicitly indicating a successful transmission of a path switch configuration to a first terminal device 220-1, the first terminal device 220-1 being connected to the first network device 210-1 via a relaying path comprising a second terminal device 220-2 and being switched to a target path between the first terminal device 220-1 and a second network device 210-2.

At block 610, the first network device 210-1 transmits to the second terminal device 220-2, one of the following: a second message used for re-configuring the relaying path, or a third message used for triggering the second terminal device 220-2 to apply a previously-received second message used for re-configuring the relaying path.

In some embodiments, the first message comprises an indication indicating the successful transmission of the path switch configuration to the first terminal device 220-1, and the first network device 210-1 receives the first message comprises: receiving the first message from one of the second network device 210-2, the second terminal device 220-2 or a CN device.

In some embodiments, the first message is a handover success message or a UE context release message received from the second network device 210-2.

In some embodiments, the first message is at least one end marker packet corresponding to at least one respective PDU session of the first terminal device 220-1 and the first message is received from a CN device.

In some embodiments, the first message is received from the second terminal device 220-2 via one of a MAC CE or an RRC signaling.

In some embodiments, the target path is either a direct path or an indirect path.

In some embodiments, the path switch configuration is associated with an I2D path switching or an I2I path switching.

In some embodiments, the path switch configuration is associated with an inter-gNB path switching.

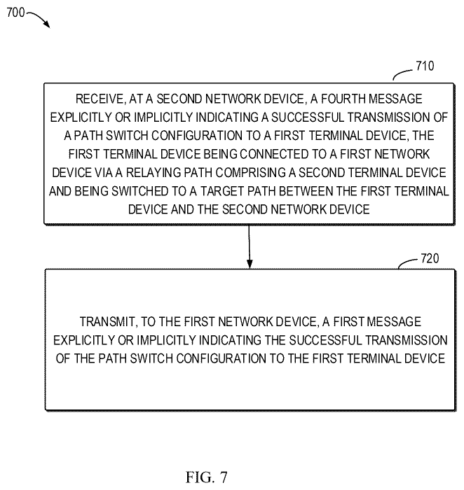

FIG. 7 illustrates a flowchart of an example method 700 in accordance with some embodiments of the present disclosure. For example, the method 700 can be implemented at the second network device 210-2 as shown in FIG. 2A.

At block 710, the second network device 210-2 receives a fourth message explicitly or implicitly indicating a successful transmission of a path switch configuration to a first terminal device 220-1, the first terminal device 220-1 being connected to a first network device 210-1 via a relaying path comprising a second terminal device 220-2 and being switched to a target path between the first terminal device 220-1 and the second network device 210-2.

At block 710, the second network device 210-2 transmits to the first network device 210-1, a first message explicitly or implicitly indicating the successful transmission of the path switch configuration to the first terminal device 220-1.

In some embodiments, the fourth message is a configuration complete message corresponding to the path switch configuration and received from one of the following: the first terminal device 220-1, or a further second terminal device 220-3 comprised in the target path and functioning as a relay device.

In some embodiments, the target path is an indirect path comprising a further second terminal device 220-3 and the further second terminal device 220-3 is in an idle or inactive state, and wherein the fourth message is one of the following: an RRC setup request received from the further second terminal device 220-3, an RRC resume request received from the further second terminal device 220-3, an RRC setup complete received from the further second terminal device 220-3, or an RRC resume complete received from the further second terminal device 220-3.

In some embodiments, the fourth message is a path switch acknowledge message received from a CN device, the path switch acknowledge message corresponding to a path switch request transmitted by the second network device 210-2 to the CN device.

In some embodiments, the first message comprises an indication indicating the successful transmission of the path switch configuration to the first terminal device 220-1.

In some embodiments, the first message is a handover success message or a UE context release message.

In some embodiments, the target path is either a direct path or an indirect path.

In some embodiments, the path switch configuration is associated with an I2D path switching or an I2I path switching.

In some embodiments, the path switch configuration is associated with an inter-gNB path switching.

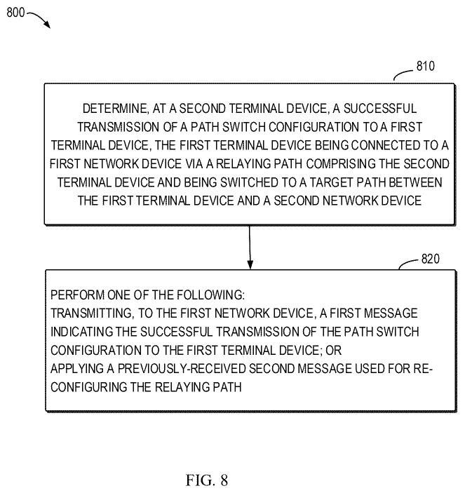

FIG. 8 illustrates a flowchart of an example method 800 in accordance with some embodiments of the present disclosure. For example, the method 800 can be implemented at the second terminal device 220-2 as shown in FIG. 2A.

At block 810, the second terminal device 220-2 determines a successful transmission of a path switch configuration to a first terminal device 220-1, the first terminal device 220-1 being connected to a first network device 210-1 via a relaying path comprising the second terminal device 220-2 and being switched to a target path between the first terminal device 220-1 and a second network device 210-2.

At block 820, the second terminal device 220-2 performs one of the following: transmitting, to the first network device 210-1, a first message indicating the successful transmission of the path switch configuration to the first terminal device 220-1; or applying a previously-received second message used for re-configuring the relaying path.

In some embodiments, applying the previously-received second message comprises at least one of the following: releasing the relaying path; releasing a connection between the second terminal device 220-2 and the first network device 210-1; or releasing a connection between the second terminal device 220-2 and the first terminal device 220-1.

In some embodiments, determining the successful transmission of the path switch configuration comprises: determining the successful transmission of the path switch configuration based on at least one of the following: the last PDU for a PC5 RLC channel corresponding to a SRB associated with the first terminal device 220-1 is transmitted to the first terminal device 220-1 successfully; an acknowledge for the last RLC PDU for a PC5 RLC channel corresponding to a SRB associated with the first terminal device 220-1 is received from the first terminal device 220-1; there is no packet buffered for a PC5 RLC channel corresponding to a SRB associated with the first terminal device 220-1; a time length without receiving a packet for a PC5 RLC channel corresponding to a SRB associated with the first terminal device 220-1 reaches a pre-configured time length; the second terminal device 220-2 is indicated by an upper layer about a release of a PC5 connection for the first terminal device 220-1; or receiving a third message used for triggering the second terminal device 220-2 to apply a previously-received second message from the first network device 210-1.

In some embodiments, the pre-configured time length is configured as a default value or configured by one of the following: system information, an RRC signaling, a MAC CE, or downlink control information.

In some embodiments, the first message comprises an indication indicating the successful transmission of the path switch configuration to the first terminal device 220-1.

In some embodiments, the target path is either a direct path or an indirect path.

In some embodiments, the path switch configuration is associated with an I2D path switching or an I2I path switching.

In some embodiments, the path switch configuration is associated with an inter-gNB path switching.

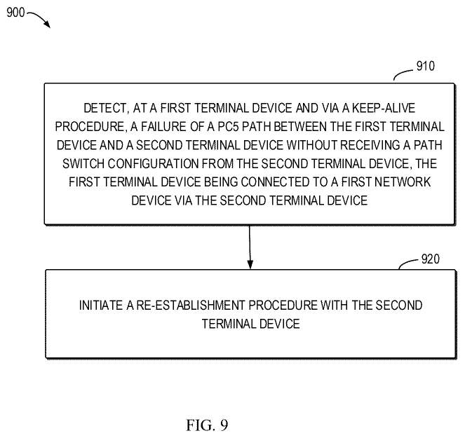

FIG. 9 illustrates a flowchart of an example method 900 in accordance with some embodiments of the present disclosure. For example, the method 900 can be implemented at the first terminal device 220-1 as shown in FIG. 2A.

At block 910, the first terminal device 220-1 detects a failure of a PC5 path between the first terminal device 220-1 and a second terminal device 220-2 without receiving a path switch configuration from the second terminal device 220-2 via a keep-alive procedure, the first terminal device 220-1 being connected to a first network device 210-1 via the second terminal device 220-2.

At block 920, the first terminal device 220-1 initiates a re-establishment procedure with the second terminal device 220-2.

In some embodiments, detecting the failure of the PC5 path comprises: detecting the failure of the PC5 path in response to at least one of the following: an expiry of timer T5080, or the number retransmissions of PROSE DIRECT LINK KEEPALIVE REQUEST message reaching a third threshold number.

In some embodiments, the path switch configuration is associated with an I2D path switching or an I2I path switching.

In some embodiments, the path switch configuration is associated with an inter-gNB path switching.

At block 1010, the CN device generates a first message explicitly or implicitly indicating a successful transmission of a path switch configuration to a first terminal device 220-1, the first terminal device 220-1 being connected to a first network device 210-1 via a relaying path comprising a second terminal device 220-2 and being switched to a target path between the first device and a second network device 210-2.

At block 1020, the CN device transmits the first message to the first network device 210-1.

In some embodiments, the first message comprises an indication indicating the successful transmission of the path switch configuration to the first terminal device 220-1.

In some embodiments, the first message is at least one end marker packet corresponding to at least one respective PDU session of the first terminal device 220-1.

In some embodiments, the target path is either a direct path or an indirect path.

In some embodiments, the path switch configuration is associated with an I2D path switching or an I2I path switching.

In some embodiments, the path switch configuration is associated with an inter-gNB path switching.

### Example of Apparatuses and Devices

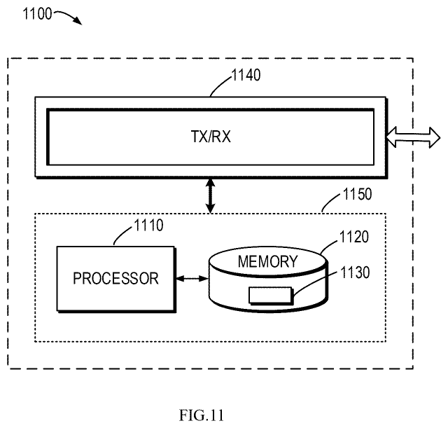

FIG. 11 is a simplified block diagram of a device 1100 that is suitable for implementing embodiments of the present disclosure. The device 1100 can be considered as a further example implementation of the first terminal device 220-1, the second terminal device 220-2, the further second terminal 220-3, the first network device 210-1 and the second network device 220-2 as shown in FIG. 2A. Accordingly, the device 1100 can be implemented at or as at least a part of the first terminal device 220-1, the second terminal device 220-2, the further second terminal 220-3, the first network device 210-1 and the second network device 220-2.

As shown, the device 1100 includes a processor 1110, a memory 1120 coupled to the processor 1110, a suitable transmitter (TX)/receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

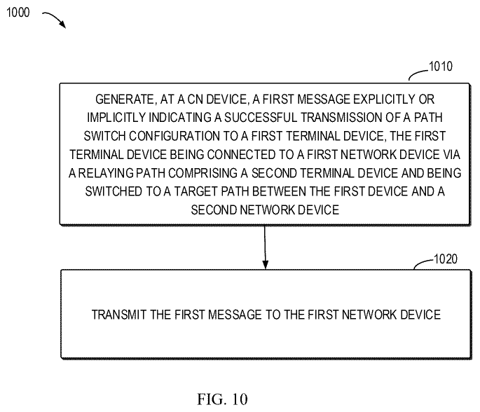

The program 1130 is assumed to include program instructions that, when executed by the associated processor 1110, enable the device 1100 to operate in accordance with the embodiments of the present disclosure, as discussed herein with reference to FIGS. 2A to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In some embodiments, a first network device 210-1 comprises a circuitry configured to: receive a first message explicitly or implicitly indicating a successful transmission of a path switch configuration to a first terminal device 220-1, the first terminal device 220-1 being connected to the first network device 210-1 via a relaying path comprising a second terminal device 220-2 and being switched to a target path between the first terminal device 220-1 and a second network device 210-2; and transmit to the second terminal device 220-2, one of the following: a second message used for re-configuring the relaying path, or a third message used for triggering the second terminal device 220-2 to apply a previously-received second message used for re-configuring the relaying path.

In some embodiments, the first message comprises an indication indicating the successful transmission of the path switch configuration to the first terminal device 220-1, and the first network device 210-1 receives the first message comprises: receiving the first message from one of the second network device 210-2, the second terminal device 220-2 or a CN device.

In some embodiments, the first message is a handover success message or a UE context release message received from the second network device 210-2.

In some embodiments, the first message is at least one end marker packet corresponding to at least one respective PDU session of the first terminal device 220-1 and the first message is received from a CN device.

In some embodiments, the first message is received from the second terminal device 220-2 via one of a MAC CE or an RRC signaling.

In some embodiments, the target path is either a direct path or an indirect path.

In some embodiments, the path switch configuration is associated with an I2D path switching or an I2I path switching.

In some embodiments, the path switch configuration is associated with an inter-gNB path switching.

In some embodiments, a second network device 210-2 comprises a circuitry configured to: receive a fourth message explicitly or implicitly indicating a successful transmission of a path switch configuration to a first terminal device 220-1, the first terminal device 220-1 being connected to a first network device 210-1 via a relaying path comprising a second terminal device 220-2 and being switched to a target path between the first terminal device 220-1 and the second network device 210-2; and transmit to the first network device 210-1, a first message explicitly or implicitly indicating the successful transmission of the path switch configuration to the first terminal device 220-1.

In some embodiments, the fourth message is a configuration complete message corresponding to the path switch configuration and received from one of the following: the first terminal device 220-1, or a further second terminal device 220-3 comprised in the target path and functioning as a relay device.

In some embodiments, the target path is an indirect path comprising a further second terminal device 220-3 and the further second terminal device 220-3 is in an idle or inactive state, and wherein the fourth message is one of the following: an RRC setup request received from the further second terminal device 220-3, an RRC resume request received from the further second terminal device 220-3, an RRC setup complete received from the further second terminal device 220-3, or an RRC resume complete received from the further second terminal device 220-3.

In some embodiments, the fourth message is a path switch acknowledge message received from a CN device, the path switch acknowledge message corresponding to a path switch request transmitted by the second network device 210-2 to the CN device.

In some embodiments, the first message comprises an indication indicating the successful transmission of the path switch configuration to the first terminal device 220-1.

In some embodiments, the first message is a handover success message or a UE context release message.

In some embodiments, the target path is either a direct path or an indirect path.

In some embodiments, the path switch configuration is associated with an I2D path switching or an I2I path switching.

In some embodiments, the path switch configuration is associated with an inter-gNB path switching.

In some embodiments, a second terminal device 220-2 comprises a circuitry configured to: determine a successful transmission of a path switch configuration to a first terminal device 220-1, the first terminal device 220-1 being connected to a first network device 210-1 via a relaying path comprising the second terminal device 220-2 and being switched to a target path between the first terminal device 220-1 and a second network device 210-2; and perform one of the following: transmitting, to the first network device 210-1, a first message indicating the successful transmission of the path switch configuration to the first terminal device 220-1; or applying a previously-received second message used for re-configuring the relaying path.

In some embodiments, applying the previously-received second message comprises at least one of the following: releasing the relaying path; releasing a connection between the second terminal device 220-2 and the first network device 210-1; or releasing a connection between the second terminal device 220-2 and the first terminal device 220-1.

In some embodiments, determining the successful transmission of the path switch configuration comprises: determining the successful transmission of the path switch configuration based on at least one of the following: the last PDU for a PC5 RLC channel corresponding to a SRB associated with the first terminal device 220-1 is transmitted to the first terminal device 220-1 successfully; an acknowledge for the last RLC PDU for a PC5 RLC channel corresponding to a SRB associated with the first terminal device 220-1 is received from the first terminal device 220-1; there is no packet buffered for a PC5 RLC channel corresponding to a SRB associated with the first terminal device 220-1; a time length without receiving a packet for a PC5 RLC channel corresponding to a SRB associated with the first terminal device 220-1 reaches a pre-configured time length; the second terminal device 220-2 is indicated by an upper layer about a release of a PC5 connection for the first terminal device 220-1; or receiving a third message used for triggering the second terminal device 220-2 to apply a previously-received second message from the first network device 210-1.

In some embodiments, the pre-configured time length is configured as a default value or configured by one of the following: system information, an RRC signaling, a MAC CE, or downlink control information.

In some embodiments, the first message comprises an indication indicating the successful transmission of the path switch configuration to the first terminal device 220-1.

In some embodiments, the target path is either a direct path or an indirect path.

In some embodiments, the path switch configuration is associated with an I2D path switching or an I2I path switching.

In some embodiments, the path switch configuration is associated with an inter-gNB path switching.

In some embodiments, a first terminal device 220-1 comprises a circuitry configured to: detect a failure of a PC5 path between the first terminal device 220-1 and a second terminal device 220-2 without receiving a path switch configuration from the second terminal device 220-2 via a keep-alive procedure, the first terminal device 220-1 being connected to a first network device 210-1 via the second terminal device 220-2; and initiate a re-establishment procedure with the second terminal device 220-2.

In some embodiments, detecting the failure of the PC5 path comprises: detecting the failure of the PC5 path in response to at least one of the following: an expiry of timer T5080, or the number retransmissions of PROSE DIRECT LINK KEEPALIVE REQUEST message reaching a third threshold number.

In some embodiments, the path switch configuration is associated with an I2D path switching or an I2I path switching.

In some embodiments, the path switch configuration is associated with an inter-gNB path switching.

In some embodiments, a CN device comprises a circuitry configured to: generate a first message explicitly or implicitly indicating a successful transmission of a path switch configuration to a first terminal device 220-1, the first terminal device 220-1 being connected to a first network device 210-1 via a relaying path comprising a second terminal device 220-2 and being switched to a target path between the first device and a second network device 210-2; and transmit the first message to the first network device 210-1.

In some embodiments, the first message comprises an indication indicating the successful transmission of the path switch configuration to the first terminal device 220-1.

In some embodiments, the first message is at least one end marker packet corresponding to at least one respective PDU session of the first terminal device 220-1.

In some embodiments, the target path is either a direct path or an indirect path.

In some embodiments, the path switch configuration is associated with an I2D path switching or an I2I path switching.

In some embodiments, the path switch configuration is associated with an inter-gNB path switching.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication, comprising: receiving, at a first network device, a first message explicitly or implicitly indicating a successful transmission of a path switch configuration to a first terminal device, the first terminal device being connected to the first network device via a relaying path comprising a second terminal device and being switched to a target path between the first terminal device and a second network device; and transmitting, to the second terminal device, one of the following: a second message used for re-configuring the relaying path, or a third message used for triggering the second terminal device to apply a previously-received second message used for re-configuring the relaying path.

In some embodiments, the first message comprises an indication indicating the successful transmission of the path switch configuration to the first terminal device, and wherein receiving the first message comprises: receiving the first message from one of the second network device, the second terminal device or a core network (CN) device.

In some embodiments, the first message is a handover success message or a user equipment (UE) context release message received from the second network device.

In some embodiments, the first message is at least one end marker packet corresponding to at least one respective packet data unit (PDU) session of the first terminal device and the first message is received from a core network (CN) device.

In some embodiments, the first message is received from the second terminal device via one of a medium access control (MAC) control element (CE) or a radio resource control (RRC) signaling.

In some embodiments, the target path is either a direct path or an indirect path.

In some embodiments, the path switch configuration is associated with an indirect to direct (I2D) path switching or an indirect to indirect (I2I) path switching.

In some embodiments, the path switch configuration is associated with an inter-gNB path switching.

In one solution, a communication device comprising: a processor; and a memory coupled to the processor and storing instructions thereon, the instructions, when executed by the processor, causing the communication device to perform any of the methods above.

In one solution, a computer readable medium having instructions stored thereon, the instructions, when executed on at least one processor, causing the at least one processor to perform any of the methods above.

In another solution, a device of communication comprises: a processor configured to cause the device to perform any of the methods above.

In one solution, a method of communication, comprising: receiving, at a second network device, a fourth message explicitly or implicitly indicating a successful transmission of a path switch configuration to a first terminal device, the first terminal device being connected to a first network device via a relaying path comprising a second terminal device and being switched to a target path between the first terminal device and the second network device; and transmitting, to the first network device, a first message explicitly or implicitly indicating the successful transmission of the path switch configuration to the first terminal device.

In some embodiments, the fourth message is a configuration complete message corresponding to the path switch configuration and received from one of the following: the first terminal device, or a further second terminal device comprised in the target path and functioning as a relay device.

In some embodiments, the target path is an indirect path comprising a further second terminal device and the further second terminal device is in an idle or inactive state, and wherein the fourth message is one of the following: a radio resource control (RRC) setup request received from the further second terminal device, an RRC resume request received from the further second terminal device, an RRC setup complete received from the further second terminal device, or an RRC resume complete received from the further second terminal device.

In some embodiments, the fourth message is a path switch acknowledge message received from a core network (CN) device, the path switch acknowledge message corresponding to a path switch request transmitted by the second network device to the CN device.

In some embodiments, the first message comprises an indication indicating the successful transmission of the path switch configuration to the first terminal device.

In some embodiments, the first message is a handover success message or a user equipment (UE) context release message.

In some embodiments, the target path is either a direct path or an indirect path.

In some embodiments, the path switch configuration is associated with an indirect to direct (I2D) path switching or an indirect to indirect (I2I) path switching.

In some embodiments, the path switch configuration is associated with an inter-gNB path switching.

In one solution, a communication device comprising: a processor; and a memory coupled to the processor and storing instructions thereon, the instructions, when executed by the processor, causing the communication device to perform any of the methods above.

In one solution, a computer readable medium having instructions stored thereon, the instructions, when executed on at least one processor, causing the at least one processor to perform any of the methods above.

In another solution, a device of communication comprises: a processor configured to cause the device to perform any of the methods above.

In one solution, a method of communication, comprising: determining, at a second terminal device, a successful transmission of a path switch configuration to a first terminal device, the first terminal device being connected to a first network device via a relaying path comprising the second terminal device and being switched to a target path between the first terminal device and a second network device; and performing one of the following: transmitting, to the first network device, a first message indicating the successful transmission of the path switch configuration to the first terminal device; or applying a previously-received second message used for re-configuring the relaying path.

In some embodiments, applying the previously-received second message comprises at least one of the following: releasing the relaying path; releasing a connection between the second terminal device and the first network device; or releasing a connection between the second terminal device and the first terminal device.

In some embodiments, determining the successful transmission of the path switch configuration comprises: determining the successful transmission of the path switch configuration based on at least one of the following: the last packet data unit (PDU) for a PC5 radio link control (RLC) channel corresponding to a signaling radio bearer (SRB) associated with the first terminal device is transmitted to the first terminal device successfully; an acknowledge for the last RLC PDU for a PC5 radio link control (RLC) channel corresponding to a signaling radio bearer (SRB) associated with the first terminal device is received from the first terminal device; there is no packet buffered for a PC5 RLC channel corresponding to a signaling radio bearer (SRB) associated with the first terminal device; a time length without receiving a packet for a PC5 radio link control (RLC) channel corresponding to an SRB associated with the first terminal device reaches a pre-configured time length; the second terminal device is indicated by an upper layer about a release of a PC5 connection for the first terminal device; or receiving a third message used for triggering the second terminal device to apply a previously-received second message from the first network device.

In some embodiments, the pre-configured time length is configured as a default value or configured by one of the following: system information, a radio resource control (RRC) signaling, a medium access control (MAC) control element (CE), or downlink control information.

In some embodiments, the first message comprises an indication indicating the successful transmission of the path switch configuration to the first terminal device.

In some embodiments, the target path is either a direct path or an indirect path.

In some embodiments, the path switch configuration is associated with an indirect to direct (I2D) path switching or an indirect to indirect (I2I) path switching.

In some embodiments, the path switch configuration is associated with an inter-gNB path switching.

In one solution, a communication device comprising: a processor; and a memory coupled to the processor and storing instructions thereon, the instructions, when executed by the processor, causing the communication device to perform any of the methods above.

In one solution, a computer readable medium having instructions stored thereon, the instructions, when executed on at least one processor, causing the at least one processor to perform any of the methods above.

In another solution, a device of communication comprises: a processor configured to cause the device to perform any of the methods above.

In one solution, a method of communication, comprising: detecting, at a first terminal device and via a keep-alive procedure, a failure of a PC5 path between the first terminal device and a second terminal device without receiving a path switch configuration from the second terminal device, the first terminal device being connected to a first network device via the second terminal device; and initiating a re-establishment procedure with the second terminal device.

In some embodiments, detecting the failure of the PC5 path comprises: detecting the failure of the PC5 path in response to at least one of the following: an expiry of timer T5080, or the number retransmissions of PROSE DIRECT LINK KEEPALIVE REQUEST message reaching a third threshold number.

In some embodiments, the path switch configuration is associated with an indirect to direct (I2D) path switching or an indirect to indirect (I2I) path switching.

In some embodiments, the path switch configuration is associated with an inter-gNB path switching.

In one solution, a communication device comprising: a processor; and a memory coupled to the processor and storing instructions thereon, the instructions, when executed by the processor, causing the communication device to perform any of the methods above.

In one solution, a computer readable medium having instructions stored thereon, the instructions, when executed on at least one processor, causing the at least one processor to perform any of the methods above.

In another solution, a device of communication comprises: a processor configured to cause the device to perform any of the methods above.

In one solution, a method of communication, comprising: generating, at a core network (CN) device, a first message explicitly or implicitly indicating a successful transmission of a path switch configuration to a first terminal device, the first terminal device being connected to a first network device via a relaying path comprising a second terminal device and being switched to a target path between the first device and a second network device; and transmitting the first message to the first network device.

In some embodiments, the first message comprises an indication indicating the successful transmission of the path switch configuration to the first terminal device.

In some embodiments, the first message is at least one end marker packet corresponding to at least one respective packet data unit (PDU) session of the first terminal device.

In some embodiments, the target path is either a direct path or an indirect path.

In some embodiments, the path switch configuration is associated with an indirect to direct (I2D) path switching or an indirect to indirect (I2I) path switching.

In some embodiments, the path switch configuration is associated with an inter-gNB path switching.

In one solution, a communication device comprising: a processor; and a memory coupled to the processor and storing instructions thereon, the instructions, when executed by the processor, causing the communication device to perform any of the methods above.

In one solution, a computer readable medium having instructions stored thereon, the instructions, when executed on at least one processor, causing the at least one processor to perform any of the methods above.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2A to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of communication performed by a first network device, the method comprising:
receiving, from a second network device, a message indicating a success of a path switch in which a remote user equipment (UE) is switching from a first indirect path to a second path, wherein the remote UE is connected to the first network device in the first indirect path, the remote UE is connected to the second network device in the second path; and
transmitting, to a relay UE, a radio resource control (RRC) reconfiguration message to release Uu Relay radio link control (RLC) channel configuration and PC5 Relay RLC channel configuration for relaying.

22. The method of claim 21, wherein the second path is a direct path or a second indirect path.

23. The method of claim 21, wherein the second network device is different from the first network device.

24. The method of claim 21, wherein the message is a UE CONTEXT RELEASE message.

25. A method of communication performed by a second network device, the method comprising:
transmitting, to a first network device, a message indicating a success of a path switch in which a remote user equipment (UE) is switching from a first indirect path to a second path, wherein the remote UE is connected to the first network device in the first indirect path, the remote UE is connected to the second network device in the second path, wherein a radio resource control (RRC) reconfiguration message is transmitted from the first network device to a relay UE to release Uu Relay radio link control (RLC) channel configuration and PC5 Relay RLC channel configuration for relaying.

26. The method of claim 25, wherein the second path is a direct path or a second indirect path.

27. The method of claim 25, wherein the second network device is different from the first network device.

28. The method of claim 25, wherein the message is a UE CONTEXT RELEASE message.

29. A method of communication performed by a relay user equipment (UE), the method comprising:
receiving, from a first network device, a first radio resource control (RRC) reconfiguration message to trigger a path switch in which a remote UE is switching from a first indirect path to a second path, wherein the remote UE is connected to the first network device in the first indirect path, the remote UE is connected to the second network device in the second path; and
receiving, from the first network device, a second RRC reconfiguration message to release Uu Relay radio link control (RLC) channel configuration and PC5 Relay RLC channel configuration for relaying.

30. The method of claim 29, wherein the second path is a direct path or a second indirect path.

31. The method of claim 29, wherein the second network device is different from the first network device.
